(19) United States
(12) Patent Application Publication
(10) Pub. No.: US 2025/0134003 A1
(43) Pub. Date: May 1, 2025

(54) BALE WRAP ASSEMBLY LOADING SYSTEM FOR AN AGRICULTURAL HARVESTER

(71) Applicant: CNH Industrial Canada, Ltd., Saskatoon (CA)

(72) Inventor: Martin J. Roberge, Quebec (CA)

(21) Appl. No.: 18/925,275

(22) Filed: Oct. 24, 2024

Related U.S. Application Data
(60) Provisional application No. 63/594,506, filed on Oct. 31, 2023.

(51) Int. Cl. A01F 15/07; A01F 15/08

(52) U.S. Cl. CPC A01F 15/0715; A01F 15/0833

(57) ABSTRACT

A bale wrap assembly loading system for an agricultural harvester includes a movable storage compartment configured to store multiple bale wrap assemblies. The movable storage compartment is configured to be positioned proximate to a surface while in a loading position, the movable storage compartment is configured to be positioned proximate to a baler of the agricultural harvester while in a working position, and the movable storage compartment is configured to move in an upward direction and in a laterally inward direction from the loading position to the working position. The bale wrap assembly loading system also includes at least one arm movably coupled to the movable storage compartment. The at least one arm is configured to move each bale wrap assembly from the surface to the movable storage compartment while the movable storage compartment is in the loading position.

### BACKGROUND

The present disclosure relates generally to a bale wrap assembly loading system for an agricultural harvester.

Agricultural harvesters are used to harvest agricultural products (e.g., cotton or other natural material(s)). For example, an agricultural harvester may include a header having drums configured to harvest the agricultural product from a field. The agricultural harvester may also include an air-assisted conveying system configured to move the agricultural product from the drums to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

### BRIEF DESCRIPTION

In certain embodiments, a bale wrap assembly loading system for an agricultural harvester includes a movable storage compartment configured to store multiple bale wrap assemblies. The movable storage compartment is configured to be positioned proximate to a surface while in a loading position, the movable storage compartment is configured to be positioned proximate to a baler of the agricultural harvester while in a working position, and the movable storage compartment is configured to move in an upward direction and in a laterally inward direction from the loading position to the working position. The bale wrap assembly loading system also includes at least one arm movably coupled to the movable storage compartment. The at least one arm is configured to move each bale wrap assembly from the surface to the movable storage compartment while the movable storage compartment is in the loading position.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system having a bale wrap assembly loading system;

FIG. 2A is a front schematic view of an embodiment of a bale wrap assembly loading system that may be employed within the agricultural system of FIG. 1, in which the bale wrap assembly loading system includes a movable storage compartment, and the movable storage compartment is in a loading position;

FIG. 2B is a front schematic view of the bale wrap assembly loading system of FIG. 2A, in which the movable storage compartment is in an intermediate position;

FIG. 2C is a front schematic view of the bale wrap assembly loading system of FIG. 2A, in which the movable storage compartment is in a working position;

FIG. 3A is a side schematic view of the bale wrap assembly loading system of FIG. 2A, in which the bale wrap assembly loading system includes an arm, the movable storage compartment is in the loading position, and the arm is in an engagement position;

FIG. 3B is a side schematic view of the bale wrap assembly loading system of FIG. 2A, in which the movable storage compartment is in the loading position, and the arm is in a first transfer position;

FIG. 3C is a side schematic view of the bale wrap assembly loading system of FIG. 2A, in which the movable storage compartment is in the loading position, and the arm is in a second transfer position;

FIG. 3D is a side schematic view of the bale wrap assembly loading system of FIG. 2A, in which the movable storage compartment is in the loading position, and the arm is in a third transfer position;

FIG. 3E is a side schematic view of the bale wrap assembly loading system of FIG. 2A, in which the movable storage compartment is in the working position, and the arm is in a storage position; and

FIG. 4 is a side schematic view of another embodiment of a bale wrap assembly loading system, in which the movable storage compartment is in the working position, and the arm is in the storage position.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

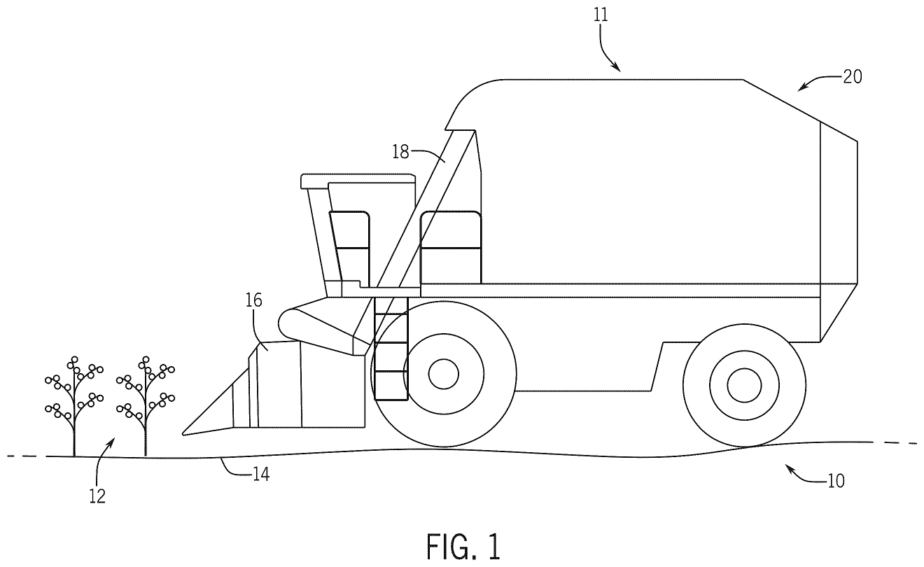

FIG. 1 is a side view of an embodiment of an agricultural system 10 (e.g., harvester, agricultural harvester) having a bale wrap assembly loading system 11. The agricultural system 10 is configured to harvest agricultural product 12 (e.g., cotton) from a field 14 and to form the agricultural product 12 into bales (e.g., agricultural bales). In the illustrated embodiment, the agricultural system 10 includes a header 16 having drums configured to harvest the agricultural product 12 from the field 14. Additionally, the agricultural system 10 includes an air-assisted conveying system 18 configured to move the agricultural product 12 from the drums of the header 16 to an accumulator of the agricultural system 10. The agricultural system 10 also includes a conveying system configured to convey the agricultural product 12 from the accumulator into a baler 20 (e.g., agricultural baler). The baler 20 is supported by and/or mounted within or on a chassis of the agricultural system 10. The baler 20 may form the agricultural product 12 into round bales. However, in other embodiments, the baler 20 of the agricultural system 10 may form the agricultural product into square bales, polygonal bales, or bales of other suitable shape(s). After forming the agricultural product 12 into a bale, a bale wrapping system of the agricultural system 10 wraps the bale with a bale wrap to secure the agricultural product 12 within the bale and to generally maintain a shape of the bale.

A bale wrap assembly provides the bale wrap to the bale wrapping system. The bale wrap assembly includes the bale wrap and a shaft, in which the bale wrap is wrapped around the shaft. As discussed in detail below, multiple bale wraps may be loaded onto the agricultural system 10 via the bale wrap assembly loading system 11. The bale wrap assembly loading system includes a movable storage compartment configured to store multiple bale wrap assemblies. The movable storage compartment is configured to be positioned proximate to a surface (e.g., ground surface) while in a loading position, and the movable storage compartment is configured to be positioned proximate to the baler while in a working position. Accordingly, the bale wrap assemblies may be loaded into the movable storage compartment from the surface (e.g., ground surface) while the movable storage compartment is in the loading position, and the bale wrap from one bale wrap assembly within the movable storage compartment may be provided to the bale wrapping system while the movable storage compartment is in the working position, thereby facilitating the bale wrapping process. As discussed in detail below, the movable storage compartment is configured to move in an upward direction and in a laterally inward direction from the loading position to the working position. Furthermore, the bale wrap assembly loading system includes an arm movably coupled to the movable storage compartment. The arm is configured to move each bale wrap assembly from the surface (e.g., ground surface) to the movable storage compartment while the movable storage compartment is in the loading position. After the movable storage compartment is loaded with bale wrap assemblies, the movable storage compartment may be moved to the working position. Accordingly, multiple bale wrap assemblies may be loaded from the surface (e.g., ground surface) to the agricultural system.

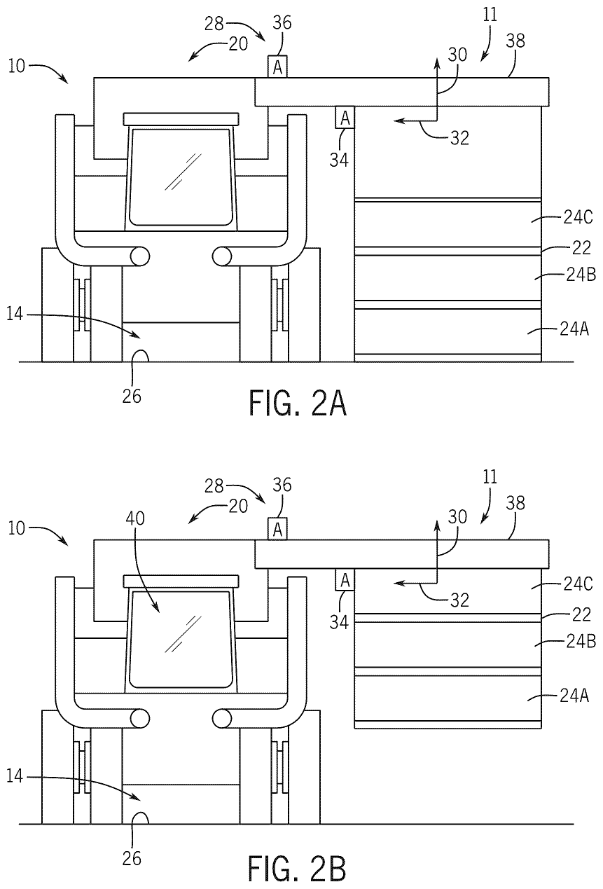

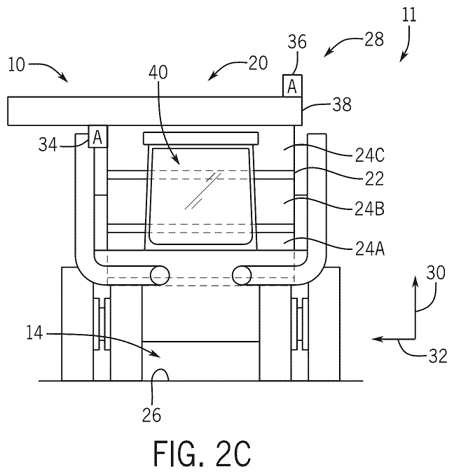

FIG. 2A is a front schematic view of an embodiment of a bale wrap assembly loading system 11 that may be employed within the agricultural system 10 of FIG. 1. In the illustrated embodiment, the bale wrap assembly loading system 11 includes a movable storage compartment 22, in which the movable storage compartment 22 is in a loading position. The movable storage compartment 22 is configured to store multiple bale wrap assemblies 24. The movable storage compartment 22 may be partially enclosed (e.g., including one or more walls), and/or the movable storage compartment 22 may include a frame. For example, in certain embodiments, the movable storage compartment may include a frame without walls. As previously discussed, each bale wrap assembly 24 includes a bale wrap and a shaft, in which the bale wrap is wrapped around the shaft. In the illustrated embodiment, the movable storage compartment 22 is configured to store three bale wrap assemblies 24, including a first bale wrap assembly 24A, a second bale wrap assembly 24B, and a third bale wrap assembly 24C. However, in other embodiments, the movable storage compartment may be configured to store more or fewer bale wrap assemblies (e.g., 2, 4, 5, 6, 7, 8, or more).

The movable storage compartment 22 is configured to be positioned proximate to a surface, such as a ground surface 26 of the field 14, while the movable storage compartment 22 is in the illustrated loading position. As used herein, “proximate” refers to a distance between the movable storage compartment 22 and a surface (e.g., the ground surface 26) that is less than a threshold distance (e.g., 1 cm, 5 cm, 10 cm, 15 cm, etc.). In the illustrated embodiment, the movable storage compartment 22 is configured to be positioned on the ground surface 26 while in the loading position. However, in other embodiments, the movable storage compartment may be configured to be positioned a small distance above the ground surface (e.g., less than 1 cm, less than 5 cm, less than 10 cm, less than 15 cm, etc.) while in the loading position. For example, in certain embodiments, each bale wrap assembly 24 may be positioned on a pallet that is on the ground surface 26. In such embodiments, the movable storage compartment may be positioned above the ground surface by a distance substantially equal to the height of the pallet while the movable storage compartment is in the loading position. Furthermore, the movable storage compartment 22 is configured to be positioned proximate to the baler 20 while in a working position.

As discussed in detail below, while the movable storage compartment 22 is in the illustrated loading position, an arm, which is movably coupled to the movable storage compartment 22, may move each bale wrap assembly 24 from a surface (e.g., the ground surface 26) to the movable storage compartment 22. For example, the arm may engage a bale wrap assembly while the bale wrap assembly is on the ground surface and the arm is in an engagement position. An actuator may drive the arm to rotate from the engagement position to a transfer position, and the arm may disengage the bale wrap assembly while the arm is in the transfer position, thereby disposing the bale wrap assembly within the movable storage compartment. The actuator may then drive the arm to move back to the engagement position to receive another bale wrap, and the process may repeat, thereby enabling multiple bale wrap assemblies to be disposed within the movable storage compartment.

In the illustrated embodiment, the bale wrap assembly loading system 11 includes an actuation assembly 28 configured to drive the movable storage compartment 22 to move in an upward direction 30 from the illustrated loading position to an intermediate position. In addition, the actuation assembly 28 is configured to drive the movable storage compartment 22 to move in a laterally inward direction 32 from the intermediate position to the working position. In the illustrated embodiment, the actuation assembly 28 includes a first actuator 34 (e.g., first movable storage compartment actuator) and a second actuator 36 (e.g., second movable storage compartment actuator). The first actuator 34 is configured to drive the movable storage compartment 22 to move in the upward direction 30, and the second actuator 36 is configured to drive the movable storage compartment 22 to move in the laterally inward direction 32. Each actuator may include any suitable type(s) of actuating device(s), such as one or more hydraulic cylinders, one or more pneumatic cylinders, one or more electric linear actuators, one or more electric motors, one or more hydraulic motors, one or more pneumatic motors, one or more other suitable actuating devices, or a combination thereof.

In the illustrated embodiment, the movable storage compartment 22 is movably coupled to a movable support 38, and the movable support 38 is movably coupled to a frame/chassis of the agricultural system 10. The first actuator 34 is configured to drive the movable storage compartment 22 to move relative to the movable support 38, and the second actuator 36 is configured to move the movable support 38 relative to the frame/chassis of the agricultural system 10. For example, to move the movable storage compartment 22 from the illustrated loading position to the intermediate position, the first actuator 34 may drive the movable storage compartment 22 to move in the upward direction 30 relative to the movable support 38. In addition, to move the movable storage compartment 22 from the intermediate position to the working position, the second actuator 36 may move the movable support 38 in the laterally inward direction 32. The movable storage compartment 22 may be movably coupled to the movable support 38 by any suitable type(s) of linkage(s), such as a scissor linkage, a track assembly, a cable system, other suitable type(s) of linkage(s), or a combination thereof. Furthermore, the movable support 38 may be movably coupled to the frame/chassis of the agricultural system 10 by any suitable type(s) of linkage(s), such as a scissor linkage, a track assembly, a cable system, other suitable type(s) of linkage(s), or a combination thereof.

FIG. 2B is a front schematic view of the bale wrap assembly loading system 11 of FIG. 2A, in which the movable storage compartment 22 is in an intermediate position. After the movable storage compartment 22 receives the bale wrap assemblies 24, the first actuator 34 may drive the movable storage compartment 22 to move in the upward direction 30 from the loading position, as shown in FIG. 2A, to the illustrated intermediate position. As a result, the movable storage compartment 22 is raised above the ground surface 26, and the movable storage compartment 22 is aligned with a receiving region 40 of the agricultural system 10 along the upward direction 30. Once the movable storage compartment 22 is in the intermediate position, the second actuator 36 may drive the movable storage compartment 22 to move in the laterally inward direction 32 from the intermediate position to the working position.

FIG. 2C is a front schematic view of the bale wrap assembly loading system 11 of FIG. 2A, in which the movable storage compartment 22 is in a working position. Once the movable storage compartment 22 is in the intermediate position, as shown in FIG. 2B, the second actuator 36 may drive the movable storage compartment 22 to move in the laterally inward direction 32 from the intermediate position to the illustrated working position. As a result, the movable storage compartment 22 is disposed within the receiving region 40 of the agricultural system 10, and the movable storage compartment 22 is positioned proximate to the baler 20.

With the movable storage compartment 22 in the illustrated working position, the bale wrap of the first bale wrap assembly 24A may be used to wrap bales of the agricultural product. For example, as discussed in detail below, the bale wrap of the first bale wrap assembly may be fed toward the bale using one or more feed rollers. The bale wrap may be directed into contact with the bale via a bale wrap applicator, and the bale wrap may be captured between the bale and belt(s) configured to drive the bale to rotate within the baler. Accordingly, rotation of the bale draws the bale wrap around the bale, thereby wrapping the bale. After the bale wrap of the first bale wrap assembly 24A is depleted, the bale wrap of the second bale wrap assembly 24B may be used to wrap bales. For example, the second bale wrap assembly 24B may be moved from the middle position, as illustrated, to the bottom position, formerly occupied by the first bale wrap assembly 24A, before the bale wrap of the second bale wrap assembly is fed toward the bale. The bale wraps of the bale wrap assemblies may be used in order from bottom to top until the bale wraps of all bale wrap assemblies are depleted.

After the bale wraps of the bale wrap assemblies 24 are depleted, the shafts of the bale wrap assemblies may be removed from the movable storage compartment 22 (e.g., if each shaft is not automatically removed after the respective bale wrap is depleted). Additional bale wrap assemblies may then be disposed within the movable storage compartment 22. For example, to load additional bale wrap assemblies 24 within the movable storage compartment 22, the second actuator 36 may drive the movable support 38 to move laterally outwardly from the illustrated working position to the intermediate position. The first actuator 34 may then drive the movable storage compartment 22 to move downwardly from the intermediate position to the loading position. Once in the loading position, additional bale wrap assemblies may be loaded into the movable storage compartment.

While the bale wrap assembly 11 includes an actuation assembly 28 having two actuators in the illustrated embodiment, in other embodiments, the actuation assembly may include more or fewer actuators. For example, in certain embodiments, one of the first actuator or the second actuator may be omitted. In such embodiments, the moveable storage compartment may be driven to move in the direction corresponding to the omitted actuator by an operator (e.g., manually, via a crank, via a lever, etc.). Furthermore, in certain embodiments, the actuation assembly may be omitted, and the movable storage compartment may be driven to move in the upward direction and the laterally inward direction by the operator (e.g., manually, via crank(s), via lever(s), etc.).

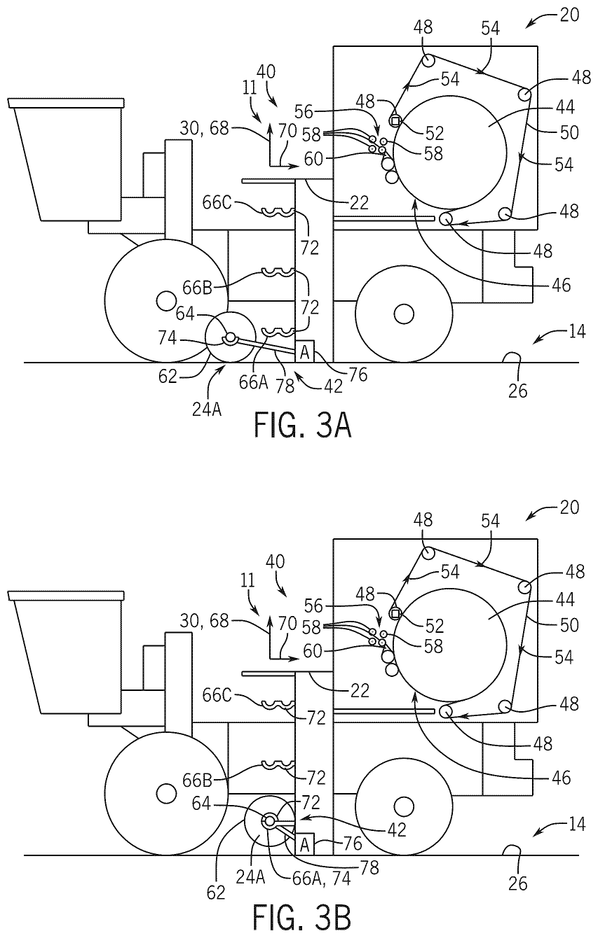

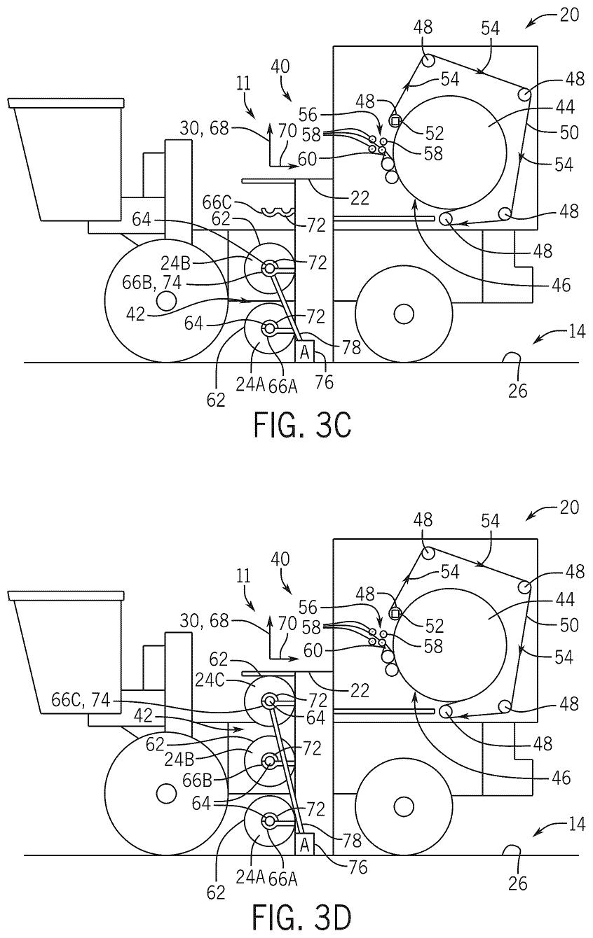

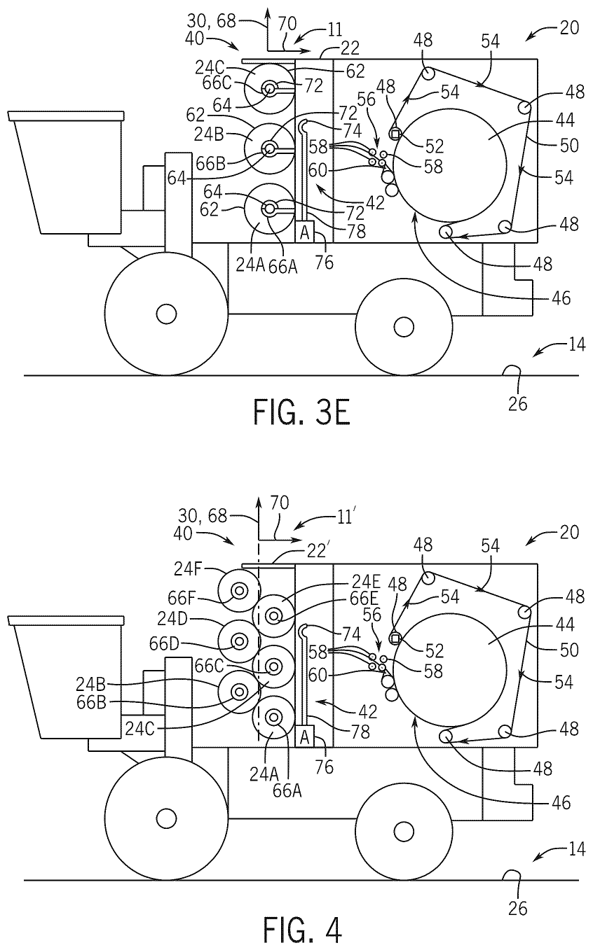

FIG. 3A is a side schematic view of the bale wrap assembly loading system 11 of FIG. 2A. In the illustrated embodiment, the bale wrap assembly loading system 11 includes an arm 42 movably coupled to the movable storage compartment 22. As illustrated, the movable storage compartment 22 is in the loading position, and the arm 42 is in an engagement position. As discussed in detail below, the arm 42 is configured to move each bale wrap assembly 24 from the ground surface 26 to the movable storage compartment 22 while the movable storage compartment 22 is in the illustrated loading position.

As previously discussed with regard to FIG. 1, the agricultural system includes a baler 20 configured to form a bale 44 of the agricultural product. As the agricultural product (e.g., cotton) is harvested, the agricultural product flows into an accumulator (e.g., bale chamber) and/or a feeding system. For example, the agricultural product may be blown by the air-assisted conveying system into the accumulator/bale chamber. The agricultural product is then fed into a cavity 46 of the baler 20 by a conveying system. The baler 20 includes multiple rollers 48 that support and/or drive rotation of one or more belts 50. For example, one or more rollers 48 engage the belt(s) 50, which enable the belt(s) 50 to move along the pathway defined by the rollers 48 and the bale 44. One or more rollers are driven to rotate via a belt drive system 52 (e.g., including electric motor(s), hydraulic motor(s), pneumatic motor(s), etc.). The belt(s) 50 circulate around the path defined by the rollers 48 and the bale 44, as indicated by arrows 54. Movement of the belt(s) 50 captures the agricultural product from the accumulator and draws the agricultural product into the cavity 46, where the agricultural product is gradually built up to form the bale 44. As the agricultural product builds within the cavity 46, one or more of the rollers 48 may move radially outward to accommodate the increasing size of the bale 44.

Once the bale 44 reaches a desired size, a bale wrapping system 56 wraps the bale 44 with a bale wrap from a respective bale wrap assembly 24. The bale wrap may include cotton, hemp, flax, plastic, bioplastic, fabric, canvas, cloth, other suitable material(s) (e.g., biodegradable material(s), natural material(s)), or a combination thereof. In certain embodiments, the bale wrap may include only cotton.

The bale wrap is fed into contact with the bale 44 with one or more feed rollers 58 and over a wrap guide or wrap applicator 60 (e.g., duckbill). The wrap guide/wrap applicator 60 is configured to move (e.g., rotate) to direct the bale wrap into contact with the bale 44. The bale wrap is captured between the bale 44 and the belt(s) 50. Accordingly, rotation of the bale 44 draws the bale wrap around the bale 44, thereby wrapping the bale 44.

As previously discussed, each bale wrap assembly 24 includes a bale wrap 62 and a shaft 64, in which the bale wrap 62 is wrapped around the shaft 64. In the illustrated embodiment, the movable storage compartment 22 includes multiple hooks 66. Each hook 66 is configured to engage the shaft 64 of a bale wrap assembly 24, thereby supporting the bale wrap assembly 24 within the movable storage compartment 22. In the illustrated embodiment, the movable storage compartment 24 includes multiple sets of hooks 66, in which each set of hooks 66 is configured to support a respective bale wrap assembly 24. For each set of hooks 66, one or more hooks 66 may be positioned on each lateral side of the movable storage compartment 22 to engage each lateral end of the shaft 64 of the respective bale wrap assembly 24, thereby supporting the bale wrap assembly 24 within the movable storage compartment 22. In the illustrated embodiment, the movable storage compartment 22 includes three sets of hooks 66 to support three bale wrap assemblies 24. However, in other embodiments, the movable storage compartment may include more or fewer sets of hooks (e.g., 2, 4, 5, 6, or more) to support a corresponding number of bale wrap assemblies.

In the illustrated embodiment, the hooks 66 (e.g., the sets of hooks 66) are arranged along a vertical axis 68 of the movable storage compartment 22 (e.g., extending along the upward direction 30). Accordingly, while the bale wrap assemblies 24 are disposed within the movable storage compartment 22, the bale wrap assemblies may be aligned with one another along a longitudinal axis 70 of the agricultural system. While the hooks 66 (e.g., the sets of hooks 66) are arranged along the vertical axis 68 in the illustrated embodiment, in other embodiments, the hooks (e.g., the sets of hooks) may be arranged in another suitable configuration. For example, as discuss in detail below, the hooks (e.g., the sets of hooks) may be distributed along the vertical axis and positioned on opposite sides of the vertical axis in an alternating pattern. Furthermore, while each bale wrap assembly 24 is supported by hooks 66 in the illustrated embodiment, in other embodiments, the movable storage compartment may include other device(s) (e.g., alone or in combination with the hooks) to support the bale wrap assemblies, such as cradle(s), axle(s), etc.

In the illustrated embodiment, the movable storage compartment 22 includes multiple locking mechanisms 72. Each locking mechanism 72 is configured to cooperate with a respective hook 66 to secure a bale wrap assembly 24 to the movable storage compartment 22. In certain embodiments, each locking mechanism 72 includes a latch rotatably coupled to the respective hook 66. Once the shaft 64 of a bale wrap assembly 24 is engaged with a hook 66, the latch of the respective locking mechanism 72 may be rotated to an engagement position, thereby capturing the shaft 64. In certain embodiments, the latches may be manually actuated by an operator after the shaft of the bale wrap assembly is engaged with the hooks. Furthermore, in certain embodiments, at least one locking mechanism 72 (e.g., each locking mechanism 72) is configured to automatically engage the shaft 64 of the bale wrap assembly 24 in response to the shaft engaging the respective hook 66. For example, in embodiments in which the locking mechanism includes a latch, the locking mechanism may also include a lever configured to drive the latch to rotate to engage the shaft in response to the shaft contacting the lever. Furthermore, in certain embodiments, at least one locking mechanism (e.g., each locking mechanism) may include a sensor configured to detect engagement of the shaft with the hook. The locking mechanism may also include an actuator configured to drive the locking mechanism to engage in response to detection of the shaft engaged with the hook. While a locking mechanism having a latch is disclosed above, in certain embodiments, the locking mechanism may include other suitable locking device(s) (e.g., alone or in combination with the latch) configured to engage the shaft to secure the shaft to the hook, such as a pin configured to engage an aperture of the shaft, an electromagnet configured to selectively activate to secure the shaft to the hook, etc. Furthermore, while the movable storage compartment 22 includes a locking mechanism 72 for each hook 66 in the illustrated embodiment, in other embodiments, the movable storage compartment may not include a locking mechanism for at least one hook. For example, in certain embodiments, the locking mechanisms may be omitted.

In the illustrated embodiment, the arm 42 includes at least one hook 74 configured to engage the shaft 64 of a bale wrap assembly 24 to support the bale wrap assembly 24. For example, in certain embodiments, the arm 42 includes a set of hooks 74, in which the set of hooks 74 includes one or more hooks 74 positioned on each lateral side of the arm 42 to engage each lateral end of the shaft 64 of the bale wrap assembly 24, thereby supporting the bale wrap assembly 24 on the arm 42. In certain embodiments, the arm includes locking mechanism(s) (e.g., one locking mechanism for each hook). Each locking mechanism is configured to cooperate with a respective hook to secure a bale wrap assembly to the arm. As disclosed above with reference to the movable storage compartment locking mechanisms, each locking mechanism may be manually or automatically actuated, and each locking mechanism may include any suitable locking device(s). Furthermore, in certain embodiments, the arm may not include locking mechanism(s). In addition, in the illustrated embodiment, the hook(s) 74 face upwardly while the arm 42 is in the engagement position. However, in other embodiments, the hook(s) may face downwardly while the arm is in the engagement position to engage the top of the shaft, and the locking mechanism(s) may engage the bottom of the shaft to couple the bale wrap assembly to the arm. While the arm 42 includes hook(s) 74 in the illustrated embodiment, in other embodiments, the arm may include other device(s) (e.g., alone or in combination with the hook(s)) to support the bale wrap assembly, such as cradle(s), axle(s), etc.

In the illustrated embodiment, the bale wrap assembly loading system 11 includes a first arm actuator (e.g., actuator) 76 configured to drive the arm 42 to rotate from the illustrated engagement position to a transfer position (e.g., first transfer position). The first arm actuator 76 may include any suitable type(s) of actuating device(s), such as one or more hydraulic cylinders, one or more pneumatic cylinders, one or more electric linear actuators, one or more electric motors, one or more hydraulic motors, one or more pneumatic motors, one or more other suitable actuating devices, or a combination thereof. The arm 42 is configured to engage a bale wrap assembly 24 while the bale wrap assembly 24 is on the ground surface 26 and the arm 42 is in the illustrated engagement position. In addition, the arm 42 is configured to disengage the bale wrap assembly 24 while the arm is in the transfer position and the bale wrap assembly 24 is disposed within the movable storage compartment 22. Accordingly, the arm 42 is configured to move each bale wrap assembly 24 from the ground surface 26 to the movable storage compartment 22 while the movable storage compartment is in the illustrated loading position. While the arm is configured to rotate between the illustrated engagement position and the transfer position in the illustrated embodiment, in other embodiments, the arm may be configured to translate or translate/rotate between the engagement position and the transfer position. Furthermore, while the arm 42 is movably coupled to the storage compartment 22 in the illustrated embodiment, in other embodiments, the arm may be movably coupled to another suitable structure of the agricultural system, such as the frame/chassis of the agricultural system. As used herein, “on the surface” (e.g., “on the ground surface”) and “from the surface” (e.g., “from the ground surface”) refer to a location of a bale wrap assembly that is directly on the surface (e.g., ground surface) or indirectly on the surface (e.g., ground surface), such as the bale wrap assembly being positioned on a mat or pallet that is directly on the surface (e.g., ground surface).

In the illustrated embodiment, the bale wrap assembly loading system 11 includes a second arm actuator (e.g., actuator) 78 configured to adjust a length of the arm 42. As discussed in detail below, controlling the length of the arm 42 controls a position of the bale wrap assembly within the movable storage compartment 22 while the arm 42 is in the transfer position. The second arm actuator 78 may include any suitable type(s) of actuating device(s), such as one or more hydraulic cylinders, one or more pneumatic cylinders, one or more electric linear actuators, one or more electric motors, one or more hydraulic motors, one or more pneumatic motors, one or more other suitable actuating devices, or a combination thereof. In certain embodiments, the second arm actuator may be omitted, and the length of the arm may be adjusted manually (e.g., via a pin/aperture assembly, via a screw drive assembly, etc.).

To move the first bale wrap assembly 24A to a first set of hooks 66A while the movable storage compartment 22 is in the illustrated loading position, the second arm actuator 78 may adjust the length of the arm 42, such that rotation of the arm 42 positions the first bale wrap assembly 24A at the first set of hooks 66A. The agricultural system 10 may then be moved to a position that aligns the hook(s) 74 of the arm 42 with the shaft 64 of the first bale wrap assembly 24A. Furthermore, the first arm actuator 76 may drive the arm 42 to rotate to the illustrated engagement position, thereby engaging the hook(s) 74 of the arm 42 with the shaft 64 of the first bale wrap assembly 24A. In embodiments in which the arm 42 includes locking mechanism(s), the locking mechanism(s) may be engaged (e.g., manually or automatically) to secure the shaft 64 of the first bale wrap assembly 24A to the arm 42. The first arm actuator 76 may then drive the arm 42 to rotate from the illustrated engagement position to a first transfer position (e.g., transfer position). With the arm 42 in the first transfer position, the shaft 64 of the first bale wrap assembly 24A engages the first set of hook 66A, thereby positioning the first bale wrap assembly 24A within the movable storage compartment 22.

FIG. 3B is a side schematic view of the bale wrap assembly loading system 11 of FIG. 2A, in which the movable storage compartment 22 is in the loading position, and the arm 42 is in the first transfer position. As previously discussed, with the arm 42 in the first transfer position, the shaft 64 of the first bale wrap assembly 24A engages the first set of hook 66A. The respective locking mechanisms 72 are engaged with the shaft 64 of the first bale wrap assembly 24A (e.g., in response to manual or automatic actuation), thereby securing the first bale wrap assembly 24A at a first position within the movable storage compartment 22. In embodiments in which the arm 42 includes locking mechanism(s), the locking mechanism(s) may be disengaged to release the shaft 64 of the first bale wrap assembly 24A from the arm 42. The first arm actuator 76 may then rotate the arm 42 from the illustrated first transfer position to facilitate moving another bale wrap assembly from the ground surface to the movable storage compartment.

FIG. 3C is a side schematic view of the bale wrap assembly loading system 11 of FIG. 2A, in which the movable storage compartment 22 is in the loading position, and the arm 42 is in a second transfer position. To move the second bale wrap assembly 24B to a second set of hooks 66B while the movable storage compartment 22 is in the illustrated loading position, the second arm actuator 78 may adjust the length of the arm 42, such that rotation of the arm 42 positions the second bale wrap assembly 24B at the second set of hooks 66B. The agricultural system 10 may then be moved to a position that aligns the hook(s) 74 of the arm 42 with the shaft 64 of the second bale wrap assembly 24B. Furthermore, the first arm actuator 76 may drive the arm 42 to rotate to the engagement position, thereby engaging the hook(s) 74 of the arm 42 with the shaft 64 of the second bale wrap assembly 24B. In embodiments in which the arm 42 includes locking mechanism(s), the locking mechanism(s) may be engaged (e.g., manually or automatically) to secure the shaft 64 of the second bale wrap assembly 24B to the arm 42. The first arm actuator 76 may then drive the arm 42 to rotate from the engagement position to the illustrated second transfer position (e.g., transfer position). With the arm 42 in the second transfer position, the shaft 64 of the second bale wrap assembly 24B engages the second set of hooks 66B, as illustrated, thereby positioning the second bale wrap assembly 24B within the movable storage compartment 22.

In addition, the respective locking mechanisms 72 are engaged with the shaft 64 of the second bale wrap assembly 24B (e.g., in response to manual or automatic actuation), thereby securing the second bale wrap assembly 24B at a second position within the movable storage compartment 22. In embodiments in which the arm 42 includes locking mechanism(s), the locking mechanism(s) may be disengaged to release the shaft 64 of the second bale wrap assembly 24B from the arm 42. The first arm actuator 76 may then rotate the arm 42 from the illustrated second transfer position to facilitate moving another bale wrap assembly from the ground surface to the movable storage compartment.

FIG. 3D is a side schematic view of the bale wrap assembly loading system 11 of FIG. 2A, in which the movable storage compartment 22 is in the loading position, and the arm 42 is in a third transfer position. To move the third bale wrap assembly 24C to a third set of hooks 66C while the movable storage compartment 22 is in the illustrated loading position, the second arm actuator 78 may adjust the length of the arm 42, such that rotation of the arm 42 positions the third bale wrap assembly 24C at the third set of hooks 66C. The agricultural system 10 may then be moved to a position that aligns the hook(s) 74 of the arm 42 with the shaft 64 of the third bale wrap assembly 24C. Furthermore, the first arm actuator 76 may drive the arm 42 to rotate to the engagement position, thereby engaging the hook(s) 74 of the arm 42 with the shaft 64 of the third bale wrap assembly 24C. In embodiments in which the arm 42 includes locking mechanism(s), the locking mechanism(s) may be engaged (e.g., manually or automatically) to secure the shaft 64 of the third bale wrap assembly 24C to the arm 42. The first arm actuator 76 may then drive the arm 42 to rotate from the engagement position to the illustrated third transfer position (e.g., transfer position). With the arm 42 in the third transfer position, the shaft 64 of the third bale wrap assembly 24C engages the third set of hooks 66C, as illustrated, thereby positioning the third bale wrap assembly 24C within the movable storage compartment 22.

In addition, the respective locking mechanisms 72 are engaged with the shaft 64 of the third bale wrap assembly 24C (e.g., in response to manual or automatic actuation), thereby securing the third bale wrap assembly 24C at a third position within the movable storage compartment 22. In embodiments in which the arm 42 includes locking mechanism(s), the locking mechanism(s) may be disengaged to release the shaft 64 of the third bale wrap assembly 24C from the arm 42. The first arm actuator 76 may then rotate the arm 42 from the illustrated third transfer position to a storage position. The bale wrap assemblies 24 may be loaded into the movable storage compartment 22 from bottom to top in a desired usage order (e.g., the bale wrap of the first bale wrap assembly is used first, the bale wrap of the second bale wrap assembly is used second, and the bale wrap of the third bale wrap assembly is used third). The bale wrap assemblies 24 may be loaded into the movable storage compartment 22 in any chronological order (e.g., the second bale wrap assembly may be loaded into the movable storage compartment before the first and third bale wrap assemblies are loaded into the movable storage compartment, etc.).

FIG. 3E is a side schematic view of the bale wrap assembly loading system 11 of FIG. 2A, in which the movable storage compartment 22 is in the working position, and the arm 42 is in the storage position. As previously discussed, after the movable storage compartment 22 receives the bale wrap assemblies 24, the first movable storage compartment actuator may drive the movable storage compartment 22 to move in the upward direction 30 from the loading position, as shown in FIGS. 3A-3D, to the intermediate position. As a result, the movable storage compartment 22 is raised above the ground surface 26, and the movable storage compartment 22 is aligned with the receiving region 40 of the agricultural system 10 along the upward direction 30. Once the movable storage compartment 22 is in the intermediate position, the second movable storage compartment actuator may drive the movable storage compartment 22 to move in the laterally inward direction from the intermediate position to the illustrated working position. As a result, the movable storage compartment 22 is disposed within the receiving region 40 of the agricultural system 10, and the movable storage compartment 22 is positioned proximate to the baler 20.

With the movable storage compartment 22 in the illustrated working position, the bale wrap 62 of the first bale wrap assembly 24A may be used to wrap the bale 44. As previously discussed, the bale wrapping system 56 wraps the bale 44 with the bale wrap 62 of the first bale wrap assembly 24A. The bale wrap 62 is fed toward the bale 44 with the feed roller(s) 58 and over the wrap guide/wrap applicator 60 (e.g., duckbill). The wrap guide/wrap applicator 60 is configured to move (e.g., rotate) to direct the bale wrap 62 into contact with the bale 44. The bale wrap 62 is captured between the bale 44 and the belt(s) 50. Accordingly, rotation of the bale 44 draws the bale wrap around the bale 44, thereby wrapping the bale 44.

The bale wrap assembly loading system 11 enables multiple bale wrap assemblies 24 to be loaded from the ground surface 26 to the agricultural system without an operator manually lifting any of the bale wrap assemblies 24. Accordingly, large bale wrap assemblies having weights greater than a single operator may manually lift may be readily loaded onto the agricultural system. As a result, the process of organizing multiple operators to load multiple bale wrap assemblies onto the agricultural system may be obviated, which may significantly reduce the duration associated with the bale wrap assembly loading process.

In certain embodiments, the movable storage compartment actuators and the arm actuators may be controlled by the operator using one or more controls (e.g., hand control(s), etc.). For example, in certain embodiments, the control(s) may be disposed on a remote, thereby enabling the operator to control the actuators from a position adjacent to the agricultural system. Furthermore, in certain embodiments, the control(s) may be disposed within the cab of the agricultural system, and one or more cameras may be directed toward the bale wrap assembly loading system. The camera(s) may output images to one or more screens within the cab, thereby enabling the operator to control the actuators from the cab.

While the bale wrap assembly loading system 11 includes a single arm 42 in the illustrated embodiment, in other embodiments, the bale wrap assembly loading system may include multiple arms. For example, the bale wrap assembly loading system may include one arm for each set of hooks, in which a length of each arm is selected such that rotation of the arm positions a bale wrap assembly at the respective set of hooks. In such embodiments, the second arm actuator may be omitted. In addition, in certain embodiments, the arm may be omitted. In such embodiments, operator(s) may manually load the bale wrap assemblies into the movable storage compartment, and/or operator(s) may use separate equipment (e.g., crane, forklift, etc.) to load the bale wrap assemblies into the movable storage compartment.

Furthermore, in certain embodiments, the bale wrap assemblies 24 may be delivered to the ground surface 26 of the field 14 (e.g., prior to initiation of the baling process). The locations of the bale wrap assemblies 24 may be output to a controller of the agricultural system, and the controller may instruct a user interface to present information indicative of the bale wrap assembly locations to the operator. For example, the user interface may display an arrow indicating the direction toward each bale wrap assembly, thereby enabling the operator to position the agricultural system for receiving the bale wrap assemblies.

In addition, while loading bale wrap assemblies from the ground surface is disclosed above, in certain embodiments, one or more bale wrap assemblies may be loaded from other suitable surface(s) (e.g., alone or in combination with the ground surface). For example, in certain embodiments, at least one bale wrap assembly may be loaded from the surface (e.g., bed, trailer, etc.) of a transport vehicle (e.g., truck, tractor, etc.). In such embodiments, the movable storage compartment is configured to be positioned proximate to the surface while in the loading position.

As previously discussed, with the movable storage compartment 22 in the illustrated working position, the bale wrap 62 of the first bale wrap assembly 24A may be used to wrap the bale 44. After the bale wrap 62 of the first bale wrap assembly 24A is depleted, the arm 42 may be used (e.g., via control of the arm actuators) to move the shaft 64 of the first bale wrap assembly 24A to a storage position (e.g., which includes a set of hooks configured to support the shaft). The arm 42 may then be used (e.g., via control of the arm actuators) to move the second bale wrap assembly 24B from the middle position, as illustrated, to the bottom position, formerly occupied by the first bale wrap assembly 24A. The bale wrap 62 of the second bale wrap assembly 24B may then be fed toward the bale to facilitate wrapping the bale. After the bale wrap 62 of the second bale wrap assembly 24B is depleted, the arm 42 may be used (e.g., via control of the arm actuators) to move the shaft 64 of the second bale wrap assembly 24B to the second set of hooks 66B. The arm 42 may then be used (e.g., via control of the arm actuators) to move the third bale wrap assembly 24C from the top position, as illustrated, the bottom position, formerly occupied by the second bale wrap assembly 24B. The bale wrap 62 of the third bale wrap assembly 24C may then be fed toward the bale to facilitate wrapping the bale. The bale wraps of the bale wrap assemblies may be used in order from bottom to top until the bale wraps of all bale wrap assemblies are depleted. Furthermore, in certain embodiments, after all of the bale wrap assemblies are depleted, the arm 42 may be used (e.g., via control of the arm actuators) to remove the shafts 64 from the storage compartment 22 (e.g., while the storage compartment 22 is in the loading position).

FIG. 4 is a side schematic view of another embodiment of a bale wrap assembly loading system 11′, in which the movable storage compartment 22′ is in the working position, and the arm 42 is in the storage position. In the illustrated embodiment, the hooks 66 (e.g., the sets of hooks) are distributed along the vertical axis 68 and positioned on opposite sides of the vertical axis 68 in an alternating pattern. As illustrated, a first bale wrap assembly 24A is disposed on a first set of hooks 66A, a second bale wrap assembly 24B is disposed on a second set of hooks 66B, a third bale wrap assembly 24C is disposed on a third set of hooks 66C, a fourth bale wrap assembly 24D is disposed on a fourth set of hooks 66D, a fifth bale wrap assembly 24E is disposed on a fifth set of hooks 66E, and a sixth bale wrap assembly 24F is disposed on a sixth set of hooks 66F. The staggered configuration of the hooks 66 enables a larger number of smaller bale wrap assemblies 24 to be stored within the same space as a smaller number of larger bale wrap assemblies (e.g., as shown in FIG. 3E). While hooks arranged along the vertical axis and hooks distributed along the vertical axis in an alternating pattern are disclosed above, the hooks may be arranged in any other suitable pattern (e.g., circular, elliptical, hexagonal, random, etc.). Furthermore, in certain embodiments, the hooks of the movable storage compartment may be reconfigurable to facilitate adjusting the arrangement of the hooks. For example, if using smaller bale wrap assemblies is desired, the hooks may be arranged in the configuration shown in FIG. 4, and if using larger bale wrap assemblies is desired, the hooks may be arranged in the configuration shown in FIG. 3E. In addition, if using a combination of smaller and larger bale wrap assemblies is desired, one or more hooks may be arranged along the vertical axis, and one or more hooks may be distributed along the vertical axis in an alternating pattern.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A bale wrap assembly loading system for an agricultural harvester, comprising:
a movable storage compartment configured to store a plurality of bale wrap assemblies, wherein the movable storage compartment is configured to be positioned proximate to a surface while in a loading position, the movable storage compartment is configured to be positioned proximate to a baler of the agricultural harvester while in a working position, and the movable storage compartment is configured to move in an upward direction and in a laterally inward direction from the loading position to the working position; and
at least one arm movably coupled to the movable storage compartment, wherein the at least one arm is configured to move each bale wrap assembly of the plurality of bale wrap assemblies from the surface to the movable storage compartment while the movable storage compartment is in the loading position.

2. The bale wrap assembly loading system of claim 1, comprising an actuation assembly configured to drive the movable storage compartment in the upward direction and in the laterally inward direction from the loading position to the working position.

3. The bale wrap assembly loading system of claim 1, wherein the movable storage compartment comprises a plurality of hooks, and each hook of the plurality of hooks is configured to engage a shaft of a bale wrap assembly of the plurality of bale wrap assemblies to support the bale wrap assembly.

4. The bale wrap assembly loading system of claim 3, wherein the movable storage compartment comprises a plurality of locking mechanisms, and each locking mechanism of the plurality of locking mechanisms is configured to cooperate with a respective hook of the plurality of hooks to secure a bale wrap assembly of the plurality of bale wrap assemblies to the movable storage compartment.

5. The bale wrap assembly loading system of claim 4, wherein each locking mechanism of the plurality of locking mechanisms is configured to automatically engage the shaft of the bale wrap assembly in response to the shaft engaging the respective hook.

6. The bale wrap assembly loading system of claim 3, wherein the plurality of hooks are arranged along a vertical axis of the movable storage compartment.

7. The bale wrap assembly loading system of claim 3, wherein the plurality of hooks are distributed along a vertical axis of the movable storage compartment and positioned on opposite sides of the vertical axis in an alternating pattern.

8. The bale wrap assembly loading system of claim 1, wherein the at least one arm comprises a hook configured to engage a shaft of a bale wrap assembly of the plurality of bale wrap assemblies to support the bale wrap assembly.

9. The bale wrap assembly loading system of claim 1, comprising an actuator configured to drive the at least one arm to rotate from an engagement position to a transfer position, wherein the at least one arm is configured to engage a bale wrap assembly of the plurality of bale wrap assemblies while the bale wrap assembly is on the surface and the at least one arm is in the engagement position, and the at least one arm is configured to disengage the bale wrap assembly while the at least one arm is in the transfer position and the bale wrap assembly is disposed within the movable storage compartment.

10. The bale wrap assembly loading system of claim 1, comprising an actuator configured to adjust a length of the at least one arm to control a position of each bale wrap assembly of the plurality of bale wrap assemblies within the movable storage compartment.

11. An agricultural harvester, comprising:
a baler configured to form a bale of agricultural product; and
a bale wrap assembly loading system, comprising:
a movable storage compartment configured to store a plurality of bale wrap assemblies, wherein the movable storage compartment is configured to be positioned proximate to a surface while in a loading position, and the movable storage compartment is configured to be positioned proximate to the baler while in a working position;
an actuation assembly configured to drive the movable storage compartment to move in an upward direction and in a laterally inward direction from the loading position to the working position;
at least one arm movably coupled to the movable storage compartment; and
an actuator configured to drive the at least one arm to rotate from an engagement position to a transfer position to move each bale wrap assembly of the plurality of bale wrap assemblies from the surface to the movable storage compartment while the movable storage compartment is in the loading position, wherein the at least one arm is configured to engage the bale wrap assembly while the bale wrap assembly is on the surface and the at least one arm is in the engagement position, and the at least one arm is configured to disengage the bale wrap assembly while the at least one arm is in the transfer position and the bale wrap assembly is disposed within the movable storage compartment.

12. The agricultural harvester of claim 11, wherein the movable storage compartment comprises a plurality of hooks, and each hook of the plurality of hooks is configured to engage a shaft of a bale wrap assembly of the plurality of bale wrap assemblies to support the bale wrap assembly.

13. The agricultural harvester of claim 12, wherein the movable storage compartment comprises a plurality of locking mechanisms, and each locking mechanism of the plurality of locking mechanisms is configured to cooperate with a respective hook of the plurality of hooks to secure a bale wrap assembly of the plurality of bale wrap assemblies to the movable storage compartment.

14. The agricultural harvester of claim 11, wherein the at least one arm comprises a hook configured to engage a shaft of a bale wrap assembly of the plurality of bale wrap assemblies to support the bale wrap assembly.

15. The agricultural harvester of claim 11, wherein the bale wrap assembly loading system comprises an actuator configured to adjust a length of the at least one arm to control a position of each bale wrap assembly of the plurality of bale wrap assemblies within the movable storage compartment.

16. A method for loading a plurality of bale wrap assemblies onto an agricultural harvester, comprising:
moving each bale wrap assembly of the plurality of bale wrap assemblies from a surface to a movable storage compartment via at least one arm movably coupled to the movable storage compartment while the movable storage compartment is in a loading position, wherein the movable storage compartment is configured to store the plurality of bale wrap assemblies; and
moving the movable storage compartment in an upward direction and in a laterally inward direction from the loading position to a working position, wherein the movable storage compartment is configured to be positioned proximate to the surface while in the loading position, and the movable storage compartment is configured to be positioned proximate to a baler of the agricultural harvester while in the working position.

17. The method of claim 16, wherein the movable storage compartment comprises a plurality of hooks, and each hook of the plurality of hooks is configured to engage a shaft of a bale wrap assembly of the plurality of bale wrap assemblies to support the bale wrap assembly.

18. The method of claim 17, comprising engaging a locking mechanism of a plurality of locking mechanisms to secure a bale wrap assembly of the plurality of bale wrap assemblies to the movable storage compartment while a shaft of the bale wrap assembly is engaged with a respective hook of the plurality of hooks.

19. The method of claim 16, wherein moving each bale wrap assembly of the plurality of bale wrap assemblies from the surface to the movable storage compartment via the at least one arm comprises rotating the at least one arm from an engagement position to a transfer position, wherein the at least one arm is configured to engage the bale wrap assembly while the bale wrap assembly is on the surface and the at least one arm is in the engagement position, and the at least one arm is configured to disengage the bale wrap assembly while the at least one arm is in the transfer position and the bale wrap assembly is disposed within the movable storage compartment.

20. The method of claim 16, comprising adjusting a length of the at least one arm before moving each bale wrap assembly of the plurality of bale wrap assemblies from the surface to the movable storage compartment via the at least one arm, wherein the length of the at least one arm controls a position of the bale wrap assembly within the movable storage compartment.
